(19) United States
(12) Patent Application Publication
(10) Pub. No.: US 2026/0206818 A1
(43) Pub. Date: Jul. 23, 2026

(54) NOZZLE FOR EXTRUDING A MATERIAL RICH IN PROTEINS AND WATER, AND SYSTEM FOR CONTINUOUS PREPARATION OF AN EXTRUDED FOOD PRODUCT

(71) Applicant: CLEXTRAL, FIRMINY (FR)

(72) Inventors: Sylvie Andrée BRUNEL, SAINT PAUL EN JAREZ (FR); Emmanuel LAVOCAT, OULLINS (FR); Jérôme MOTTAZ, SAINT-MAURICE DE LIGNON (FR); Didier Pierre Claude SALQUES, SAINT-PRIEST-EN-JAREZ (FR)

(21) Appl. No.: 18/716,229

(22) PCT Filed: Dec. 19, 2022
(86) PCT No.: PCT/EP2022/086711

§ 371 Date: Jun. 4, 2024

(30) Foreign Application Priority Data
Dec. 20, 2021 (FR) FR2113973

(51) Int. Cl. A23P 30/20; A23J 3/26

(52) U.S. Cl. CPC A23P 30/20; A23J 3/26

(57) ABSTRACT

The nozzle or die delimits, successively according to its axis, i) a channel which extends, centered on the axis from an upstream end, opening onto the upstream side of the die, to a downstream end, ii) two branches which extend straight on either side of the axis, diverging from one another from the upstream ends, axially abutting the downstream end of the channel, to the downstream ends, and iii) two ducts which extend on either side of and parallel to the axis from the upstream ends, abutting the downstream ends of the branches, to the downstream ends opening out on the downstream side of the die, each of the ducts having a section, in a plane perpendicular to the axis, which is constant between the upstream and downstream ends of the duct, so that the material flows into the channel and is distributed into the branches before reaching the ducts.

This is a National Stage application of PCT international application PCT/EP2022/086711, filed on Dec. 19, 2022, which claims priority from French Patent Application No. 21 13973, filed on Dec. 20, 2021, both which are incorporated herein by reference in their entirety.

The present invention relates to a nozzle or die for extruding a material rich in proteins and water. It also relates to a system for continuously preparing an extruded food product, comprising such a die.

The invention concerns extrusion machines including a barrel inside of which one or more screws, in particular two screws, are driven in rotation on themselves so that a material to be extruded is driven from an upstream portion of the barrel to the downstream end of the barrel, where the material is then forced to flow through an extrusion die, provided to shape, texture and/or fiberize the extruded material. Such an extrusion machine applies a thermomechanical treatment to the material, in the sense that this material undergoes both an essentially mechanical transformation, by pressurization and shearing by the screws, and an essentially thermal transformation, by temperature regulation along the barrel.

The invention relates more specifically to the extrusion of materials rich in protein and water, as well as to the associated systems for the continuous preparation of an extruded food product from a raw material rich in proteins and water. The proteins in the raw material may be of animal and/or vegetable origin and/or of another origin. In all cases, the proteins are mixed with a significant proportion of water, as well as, possibly, fats and additives, and the corresponding mixture is subjected to the thermomechanical treatment applied by the extrusion machine in order to be heated and then gelled before being shaped in the die. Texturing, otherwise known as fiberization, of the food product essentially takes place in the die of the extrusion machine, which the material emerging from the barrel of the extruder passes through by being pushed by the screws in the machine. This method for preparing food products based on fibrated protein is known as “CEMH”, which stands for “Cuisson-Extrusion en Milieu Humide”, as well as under the name of “HME”, which stands for “High Moisture Extrusion”.

WO 03/007729 discloses an HME method and an associated extrusion machine, in which a die is provided for controlled cooling of the material passing through it, by causing the material to flow through a single duct which presents both long, typically several meters, and rectangular in section, a temperature profile being applied along this duct by temperature control means in an ad hoc manner to reduce the temperature of the material progressively between the inlet and the outlet of the duct. The material in contact with the cooled duct wall tends to adhere to this wall, which allows the laminar flow of material in the duct to be sheared. This shearing helps to develop flow lines within the material paste, and tends to align denatured macromolecules in the direction of flow. In practice, fiberization control requires a long duct and, consequently, a long processing time in the die. In addition, the viscosity of the material thus progressively fibrated means that the flow of material through the pipe remains moderate.

EP 0 398 315 discloses an installation for manufacturing a fibrous product from a raw material of fish and shellfish. This installation includes an extruder comprising a barrel and two screws that rotate inside the barrel to push the raw material through. This installation also includes, at the barrel outlet, a die system, through which the material leaving the barrel flows. This die system comprises, successively from upstream to downstream, (i) a central channel, which is aligned with the barrel outlet, (ii) two arcuate bypass tubes, which each extend from the central channel, diverging from one another from upstream to downstream, (iii) two feed pumps, the respective inlets of which are directly connected to the respective outlets of the bypass tubes, and (iv) two temperature controlled cooling tubes, the upstream ends of which are respectively directly connected to the respective outlets of the feed pumps, and the respective downstream ends of which open to the exterior. The cooling tubes respectively delimit straight ducts for the flow of material, which are parallel to each other and which, in the upstream part, extend respectively through the feed pumps, the cross-section of each of these straight ducts being necessarily variable at the level of the feed pumps, by the very presence of these feed pumps. As explained in EP 0 398 315, the use of feed pumps is an essential feature of its technical teaching: indeed, by arranging the feed pumps in the upstream part of the aforementioned straight ducts, the feed pumps are interposed between the outlet of the bypass tubes and the inlet of the cooling tubes, in order that the supply of material to the cooling tubes does not use the extrusion force of the extruder, but is carried out by the feed pumps. In this way, the material feed to the aforementioned straight ducts is disconnected from the material thrust at the outlet of the extruder. The cooling tubes can thus be fed with material in a controlled manner, in particular without the intermittence likely to occur at the outlet of the extruder.

Having said this, it should be noted that any attempt to increase the flow rate of material leaving a die used with a CEMH method comes up against operating difficulties linked to the viscous nature of the material progressing through the die and to the constraints of controlling the state of fibration of the material leaving the die. A rudimentary approach, which consists of the parallel use of several dies fed at the inlet by the output of the same extrusion machine, is not viable, as the cost of the installation is substantial and, above all, the distribution of the material between the output of the extrusion machine and the respective inputs of the dies is difficult to balance and induces considerable pressure losses.

The aim of the present invention is to propose a new die for the extrusion of a material rich in protein and water, which, while being economical, allows a high output rate to be had, without degrading control of the state of the fibration of the product leaving the die.

To this end, the invention has as its object a die for extruding a material rich in proteins and water. The die defines a die axis and has two opposite sides according to the die axis, namely an upstream side through which the material enters the die and a downstream side through which the material leaves the die. The die delimits successively according to the direction of the die axis (i) a channel which extends in a manner centered on the die axis from an upstream end, opening onto the upstream side of the die, to a downstream end, (ii) two branches, which extend on either side of the die axis, diverging from each other, from respective upstream ends, axially abutting the downstream end of the channel, to respective downstream ends, each of the branches extending substantially in a straight line from the upstream end of the branch to the downstream end of the branch, and (iii) two ducts, which extend on either side of and in a manner substantially parallel to the die axis from respective upstream ends, abutting respectively the downstream ends of the branches, to respective downstream ends, opening onto the downstream side of the die, each of the ducts having a cross-section, in a plane perpendicular to the die axis, which is constant between the upstream end and the downstream end of the duct, in such a manner that, when the material is pushed through the die from the upstream side, the material flows into the channel and is then distributed in the branches before reaching the ducts in which, under effect of the material being pushed through the die from the upstream side, the material progresses to the downstream side where the material leaves the ducts in the form of two respective product streams. The die is provided with a temperature control equipment able (i) to control a wall temperature of the ducts, (ii) to control a wall temperature of the branches and (iii) to control a wall temperature of the channel.

The invention also has as its object a system for continuously preparing an extruded food product, comprising:
a raw material which is rich in proteins and water,
a barrel inside which at least one screw is driven in such a manner as to apply a thermomechanical treatment to the raw material, and
a die, which is as defined above and which is attached to the barrel in such a manner that the material leaving the barrel is pushed by the at least one screw through the die from the upstream side of the die.

One of the ideas behind the invention is to design an extrusion die which, while ensuring good heat exchange with the material passing through the die after having been admitted by a single inlet, distributes the material in a homogeneous manner in two superimposed, substantially parallel ducts from which two product streams leave at the die outlet, which allows the output of material at the outlet to be doubled compared with a single duct die, such as mentioned above. To this end, the invention provides that, upstream of the two aforementioned ducts in which the state of fibration of the material is temperature controlled, the material entering the die is first channeled into a central channel of the die before being distributed into two branches of the die, the respective upstream ends of which are joined to the downstream end of the central channel and which diverge, from each other, downstream. One of these two branches thus extends from the central channel to the upstream end of one of the two aforementioned ducts, while the other branch thus extends from the central channel to the other of the two ducts. The central channel and the two branches are temperature controlled and each of the two branches is substantially straight from its upstream end to its downstream end, which allows the flow of material to be controlled during its distribution between the two ducts, in particular by ensuring the homogeneity of this distribution and limiting pressure losses. The die in accordance with the invention thus allows to control the flow of material, effectively and finely, at high flow rates through this die, and by this, to control the fiberization of the extruded food product which is continuously prepared by the system in accordance with the invention. Due to the arrangement of the central channel, the two diverging, substantially straight branches and the two substantially parallel ducts, the die in accordance with the invention presents a reasonable manufacturing cost and is compact compared to a solution with two independent dies used in parallel. In particular, the die in accordance with the invention occupies a footprint that is similar to that of a single-duct die.

According to further advantageous features of the die and/or system in accordance with the invention:
Each of the branches has, from the upstream end of the branch to the downstream end of the branch, a succession of sections in respective planes perpendicular to the die axis, which sections define respective centers, an union of which forms a branch axis that is substantially straight and forms with the die axis an angle of less than 30°, preferably less than 20°, even more preferably less than 15°.
The branches are delimited by (i) respective substantially flat first surfaces of the die, which are both perpendicular to the same geometric plane containing the die axis and which are located on either side of the die axis, each being turned away from the die axis, these two substantially flat first surfaces extend from the respective upstream ends to the respective downstream ends of the branches, diverging from one another, notably, in a symmetrical manner relative to the die axis, and (ii) respective substantially flat second surfaces of the die, which are both perpendicular to the geometrical plane and are located on either side of the die axis, each being turned toward the die axis, these two substantially flat second surfaces extend from the respective upstream ends to the respective downstream ends of the branches, diverging from one another, notably in a symmetrical manner relative to the die axis.
The substantially flat first surface and the substantially flat second surface of each of the branches are substantially parallel to each other and are inclined relative to the die axis at substantially the same angle which is less than 30°, preferably less than 20°, even more preferably less than 15°.
The section of each of the ducts in a plane perpendicular to the die axis has a substantially rectangular outline having longitudinal edges that extend in a manner substantially perpendicular to the geometric plane, a width of the substantially rectangular outline being between 4 and 25 mm, preferably between 6 and 20 mm.
The cumulative section of the branches in a plane both perpendicular to the die axis and located at the respective downstream ends of the branches is equal to or less than (i) a cumulative section of the branches in any plane both perpendicular to the die axis and located upstream of the respective downstream ends of the branches, and (ii) a section of the channel in any plane both perpendicular to the die axis and located between the upstream end and the downstream end of the channel.

The die includes modules juxtaposed successively to one another according to the die axis from the upstream side to the downstream side of the die, namely (i) an upstream module, which delimits both the channel and the branches and incorporates a first portion of the temperature control equipment, able to control the wall temperature of the branches and the wall temperature of the channel, and (ii) one or more downstream modules, which delimit the ducts and incorporate a second portion of the temperature control equipment, able to control the wall temperature of the ducts.
The barrel includes, at a downstream end of the barrel, an end plate delimiting a through bore which is centered on the die axis and which abuts the upstream end of the channel in such a manner that the bore directs the material pushed by the at least one screw toward the channel.
The system further includes a conveying tool that is arranged on the downstream side of the die and is able to convey the two product streams individually.

The invention will be better understood on reading the following description, given by way of example only and with reference to the drawings in which:

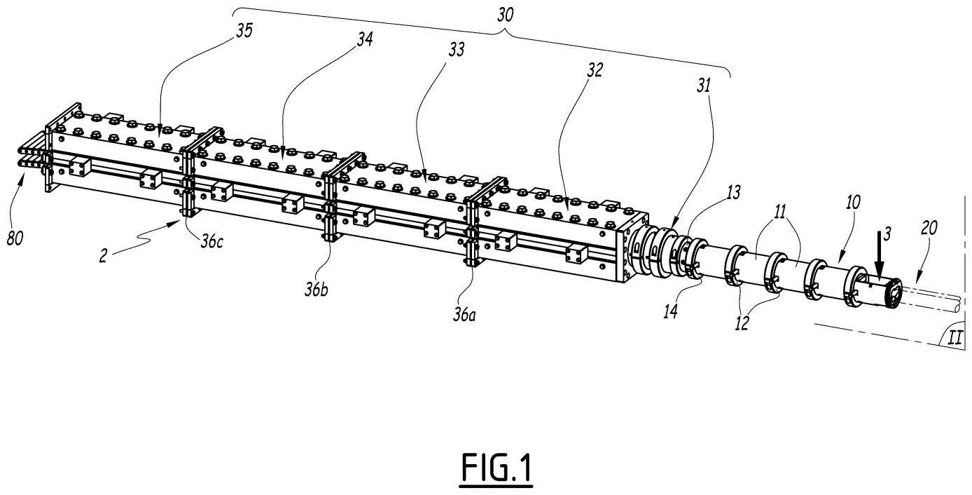

FIG. 1 is a perspective view of a system in accordance with the invention;

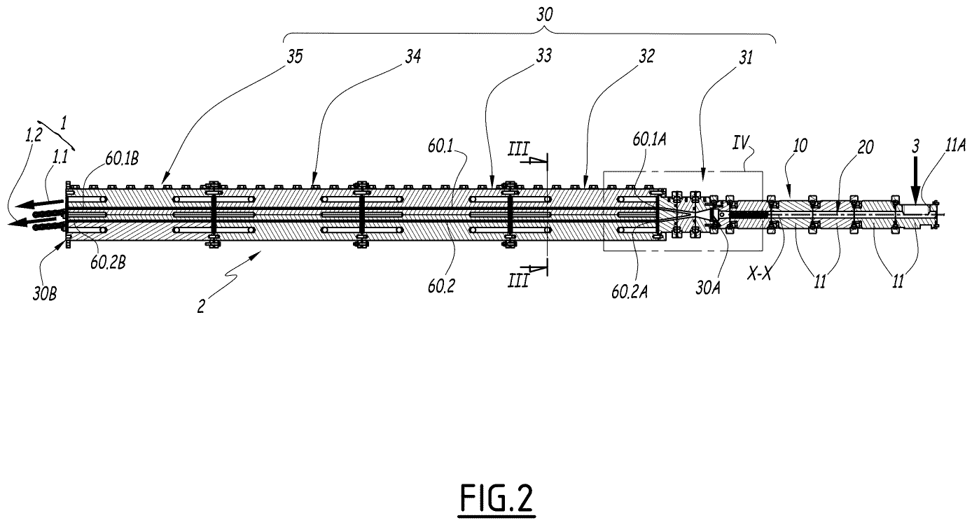

FIG. 2 is a longitudinal section in plane II of FIG. 1;

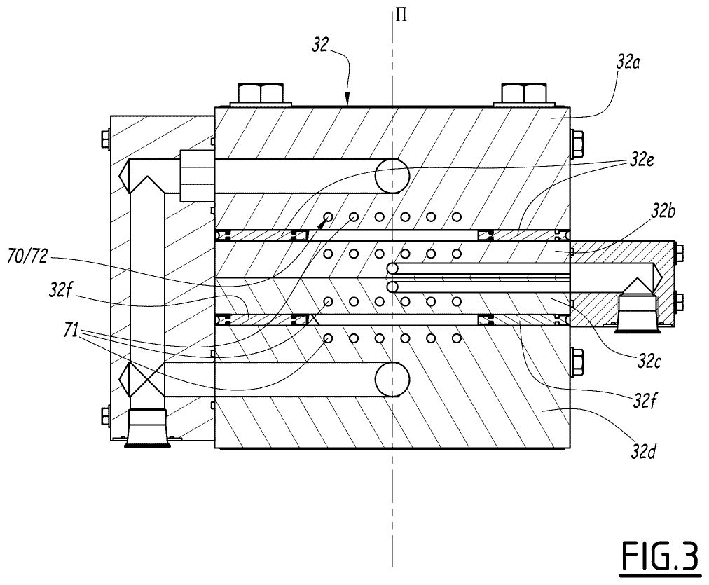

FIG. 3 is a section according to the line III-III of FIG. 2;

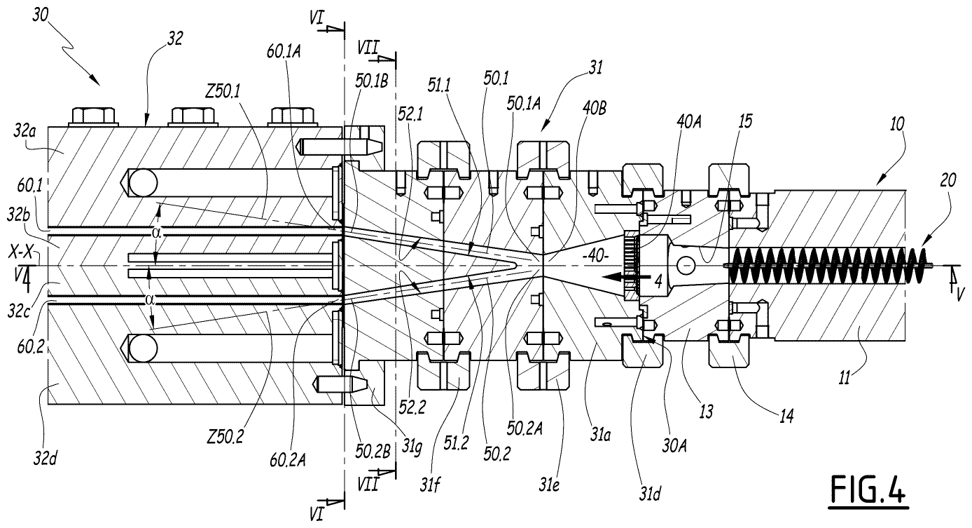

FIG. 4 is a larger-scale view of the framed detail IV on FIG. 2, including a die in accordance with the invention;

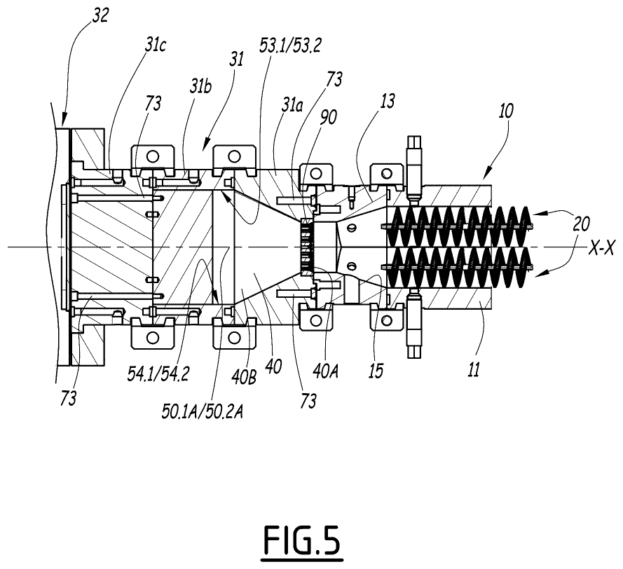

FIGS. 5, 6 and 7 are cross-sections respectively according to the lines V-V, VI-VI and VII-VII of FIG. 4;

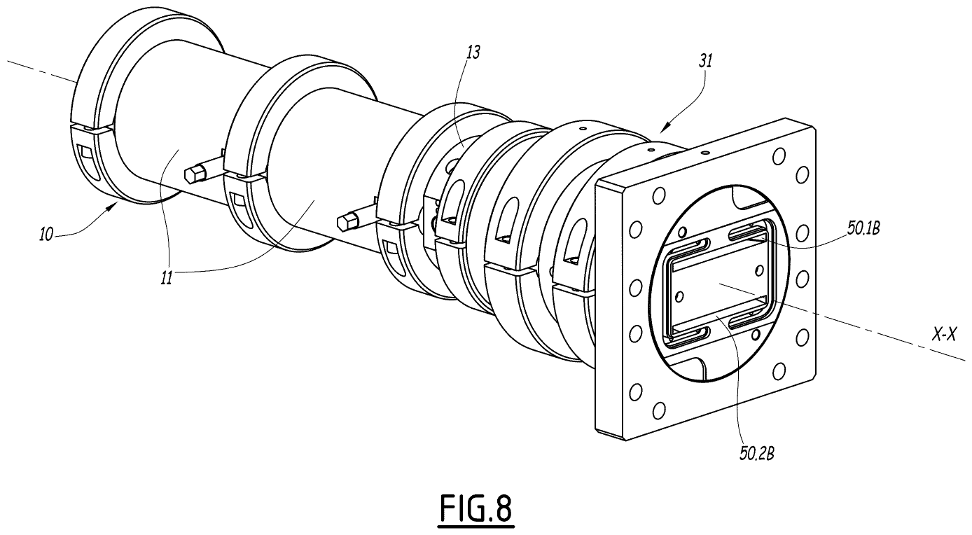

FIG. 8 is a perspective view of only one portion of the system shown in FIG. 1; and

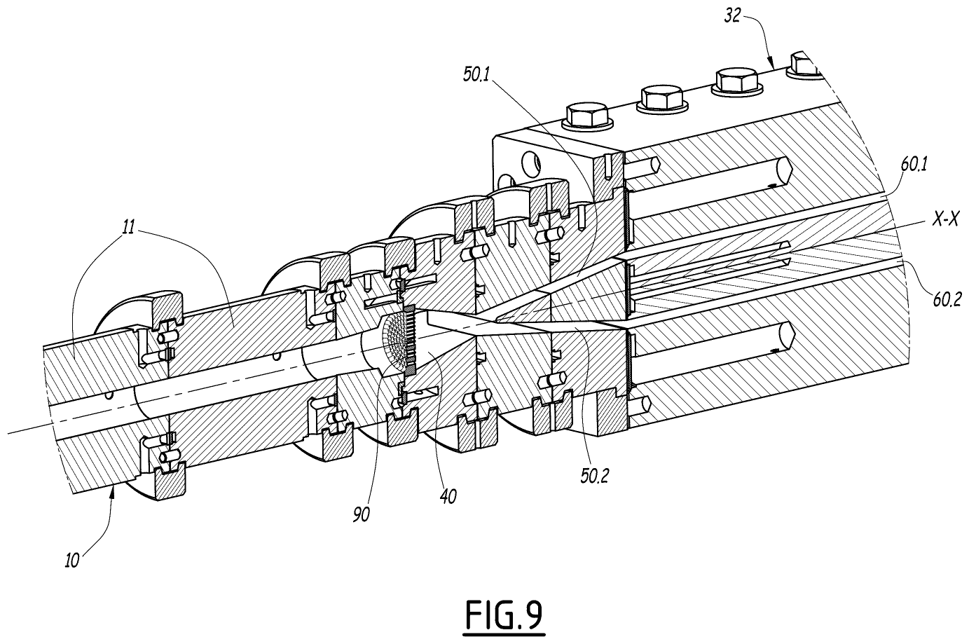

FIG. 9 is also a perspective view of part of the system of FIG. 1, cut according to the plane II.

FIGS. 1 to 9 show in a schematical manner a system allowing for the continuous preparation, by extrusion, of a food product 1 intended for human and/or animal consumption. This system principally includes an extrusion machine 2, detailed below, and a raw material 3.

The raw material 3 is rich in proteins and water. More precisely, the raw material 3, in other words, all the ingredients processed by the extrusion machine 2 to form the food product 1, contains predominantly, in other words, more than 50% by weight, water and proteins, as well as, to a lesser or even marginal extent, dietary fibers and/or starch, and possibly fats and additives.

The food product 1, such as is obtained on output from the extrusion machine 2, is textured, in other words, fibrous. The food product 1 comprises between 25 and 90% by weight, preferably between 50 and 85% by weight, of water and also comprises, by weight of the total dry material between 20 and 90% protein.

The proteins in the raw material 3 and therefore in the food product 1 are of plant and/or animal origin and/or at least one other origin. The proteins of plant origin come, for example, from legumes, cereals and/or protein crops (soya, wheat, peas, corn, chickpeas, lentils, etc.). The animal proteins are, for example, derived from fish, meat, milk and/or eggs. Other protein sources are, for example, mushrooms, algae, insects, cellular meat, etc.

The food product 1 also comprises, by weight of total dry material, between 0 and 50% dietary fiber and between 0 and 50% starch, the sum of dietary fiber and/or starch preferably being greater than 0.01%. The dietary fibers are, for example, fibers of plant origin and the starch is, for example, of plant origin, in its native, pregelatinized or modified state.

The food product 1 may also comprise, by weight of the total dry material, between 0 and 20% fat, in particular of vegetable and/or animal origin, and/or functional ingredients, such as lecithin, caseinates or other ingredients.

The extrusion machine 2 includes an elongated barrel 10, which extends along a geometric axis X-X and is centered on this axis. Inside the barrel 10, two screws 20 extend in a parallel manner to the axis X-X, being received in a complementary longitudinal bore of the barrel, centered on the axis X-X. As can be seen from FIGS. 1, 4 and 5, the screws 20 extend on either side of the axis X-X, while being interpenetrating, the bore of the barrel 10 thus presenting a bi-lobed transverse profile. In practice, in a manner known per se and not detailed in the figures, each screw 20 includes, for example, a central screw shaft on which a set of screw elements is mounted.

The screws 20 are provided to be driven in rotation on themselves, about their central axis, by a drive unit, not shown in the figures, in engagement with the upstream end of the screws, namely the right-hand end in FIGS. 1 and 2, emerging from the outside of the barrel 10.

By virtue of their threaded profile, the screws 20 are designed to drive the raw material 3 inside the barrel 10 according to the axis X-X, from an upstream portion of the barrel 10, into which the ingredients of the raw material 3 are introduced inside the central longitudinal bore of the barrel, to the downstream end of the barrel 10, the terms “upstream” and “downstream” being oriented in the direction of progress of the material in the extrusion machine 2 under the action of the screws 20. This direction is from the right toward the left in FIGS. 1, 2, 4 and 5, but from the left toward the right in FIG. 9, where the screws 20 are not shown.

The barrel 10 includes a number of modular elements 11 arranged in succession along the axis X-X. Each of the elements 11 internally delimits a corresponding portion of the central longitudinal bore of the barrel 10, these portions of the bore being in line with one another, according to the axis X-X, in the assembled state of the elements 11, as shown in the figures. In practice, the elements 11 are assembled in pairs by the clamps 12.

In the example embodiment shown in the figures, the element the most upstream from among the elements 11 allows the ingredients of the raw material 3 to be introduced into its central bore. To this end, in a manner known per se and not detailed here, this most upstream element from among the elements 11 is provided with a through orifice 11A which, transversely to the axis X-X, opens toward the exterior of the central bore portion of this element. More generally, it is understood that, from among the various elements 11 of the barrel 10, one or more of these allows to introduce, into the central longitudinal bore of the barrel 10, the solid and/or liquid ingredients of the raw material 3 for processing by the extrusion machine 2.

As mentioned in the introductory part of this present document, the screws 20 are designed, not only to drive the material to be extruded, but also to shear and pressurize the raw material 3, so as to transform it in an essentially mechanical manner. As this aspect of the extrusion machine 1 is well known in the field, it will not be described further here. Likewise, as mentioned in the introductory section, the barrel 10 is designed to regulate the temperature of the material to be extruded along the barrel, in such a way as to transform this material in an essentially thermal manner. To this end, all or some of the elements 11 of the barrel 10 are temperature controlled and/or allow steam to be injected into the barrel and/or allow the material being extruded in the barrel to be degassed. Again, this aspect of the extrusion machine 1 being well known in the field, it will not be described further here. More generally, the barrel 10 and the screws 20 are provided to apply thermomechanical treatment to the raw material 3 as this material progresses from the upstream end of the barrel to the downstream end of the barrel. The material resulting from this thermomechanical treatment and leaving the barrel 10 is referenced 4.

At its downstream end, the barrel 10 comprises an end plate 13, commonly referred to as a “front plate” in the field. The end plate 13 is fixedly attached, for example by a clamp 14, to the downstream end of the furthest downstream element, from among the elements 11 of the barrel 10. As can be clearly seen in FIGS. 4 and 5, the end plate 13 internally delimits a through bore 15, which is centered on the axis X-X, extending in axial extension of the central bore portion of the most downstream element of the elements 11, and which, where appropriate, receives the downstream end of the screws 20. This bore 15 is able to, in particular by its shape, to channel the material 4 pushed toward the downstream by the screws 20 in such a way as to ensure an appropriate pressurization and filling rate for the central longitudinal bore of the barrel 10. This aspect of the extrusion machine 2 not being limiting to the invention, will not be described further here.

The extrusion machine 2 also comprises a die 30 which, in the assembled state of the extrusion machine 2, is arranged at the downstream end of the barrel 10, being aligned with the axis X-X. The die 30 thus defines a geometric axis, about and along which the die 30 is arranged and which, in the assembled state of the extrusion machine 2, is coincident with the axis X-X so that, hereafter, this geometric axis will be considered to be the axis X-X. The die 30 is provided to be traversed according to the axis X-X by the material 4 in order to extrude it. According to the axis X-X, the die 30 thus presents two opposite sides, namely an upstream side 30A, through which the material 4 leaving the barrel 10 enters the die 30 and is forced, by the action of the screws 20, to flow through the die 30, and a downstream side 30B, through which the material leaves the die 30, forming the food product 1.

In the embodiment shown in the figures, the die 30 includes modules successively juxtaposed to one another according to the axis X-X from the upstream side 30A to the downstream side 30B of the die 30, namely an upstream module 31 and downstream modules, which are provided here in four examples and are referenced 32, 33, 34 and 35 respectively. Each of the upstream module 31 and the downstream module 32 to 35 presents two opposite sides according to the axis X-X, namely an upstream side and a downstream side. The upstream side of the upstream module 31 belongs to the upstream side 30A of the die 30. The downstream side of the upstream module 31 is axially juxtaposed to the upstream side of the downstream module 32. The downstream side of the downstream module 32 is axially juxtaposed to the upstream side of the downstream module 33. The downstream side of the downstream module 33 is axially juxtaposed to the upstream side of the downstream module 34. The downstream side of the downstream module 34 is axially juxtaposed to the upstream side of the downstream module 35. The downstream side of the downstream module 35 belongs to the downstream side 30B of the die 30.

The upstream module 31 is designed to channel, successively, according to the axis X-X, the material 4 entering the upstream module 31 by the upstream side of this latter, and to divide this material into two streams which, in particular in a symmetrical manner, diverge from the axis X-X downstream until they reach the downstream side of the upstream module 31, by means of which, these two material streams leave the upstream module 31 separately from each other. As described in more detail below, the upstream module 31 delimits for this purpose, successively according to the direction of the axis X-X, a channel 40, which opens onto the upstream side of the upstream module 31, and the two branches 50.1 and 50.2, which extend in a divergent manner from the downstream of the channel 40 until they open onto the downstream side of the upstream module 31 separately from each other. The downstream modules 32 to 35 are each designed to allow the material to flow from the upstream side to the downstream side of the downstream module under consideration, in two separate flows, parallel to the axis X-X and located on either side of the axis X-X, which enter the downstream module under consideration by the upstream side of the latter in a manner distinct from each other, and which leave the downstream module under consideration by the downstream side of the latter in a manner distinct from each other. The upstream module 31 and the downstream module 32 are axially juxtaposed in such a way that the two material flows leaving the upstream module 31 form the two material flows entering the downstream module 32. The downstream modules 32 to 35 are axially juxtaposed in such a way that the two material flows leaving each of the modules 32 to 34 form the two material flows entering the modules 33 to 35 respectively, and in such a way that the two material flows leaving the downstream module 35 form two product flows 1.1 and 1.2, which are distinct from each other and together constitute the food product 1. As will be described in more detail below, the downstream modules 32 to 35 delimit two channels 60.1 and 60.2 for this purpose, which open on the upstream side of the downstream module 32 and extend in a manner parallel to the axis X-X from the downstream side of the branches 50.1 and 50.2 respectively, until they open separately on the downstream side of the downstream module 35.

As can be seen in FIGS. 4, 5 and 9, the channel 40 presents an upstream end 40A which opens onto the upstream side of the upstream module 31, in other words, onto the upstream side 30A of the die 30. In the assembled state of the extrusion machine 2, the upstream end 40A of the channel 40 abuts the bore 15 of the end plate 13, more precisely at the downstream end of this bore 15, in order to allow the flow of the material 4 between the bore 15 and the channel 40. The cross-section of the upstream end 40A of the channel 40, in other words, the section of this upstream end 40A in a plane perpendicular to the axis X-X, is advantageously adjusted to that of the downstream end of the bore 15, in particular to limit pressure losses or disturbances in the flow of material. In the example embodiment shown here, this cross-section of the upstream end 40A of channel 40 presents a circular outline, centered on the axis X-X.

Contrary to its upstream end 40A, the channel 40 presents a downstream end 40B which, according to the axis X-X, is located in an intermediate region between the upstream and downstream sides of the upstream module 31. The downstream end 40B of the channel 40 is, according to the axis X-X, abutted to the branches 50.1 and 50.2 to allow material to flow between the channel 40 and the branches 50.1 and 50.2. In the example embodiment shown in the figures, the cross-section of the downstream end 40B of the channel 40 presents a rectangular outline, centered on the axis X-X.

As can be seen from FIGS. 4, 5 and 9, the channel 40 extends from its upstream end 40A to its downstream end 40B, in a centered manner on the axis X-X. At any point along the axis X-X between the upstream end 40A and the downstream end 40B of the channel 40 inclusive, the cross-section of the channel 40 is centered on the X-X axis. In practice, the cross-section of the channel 40 varies as you travel along the axis X-X from the upstream end 40A to the downstream end 40B of channel 40, so as to progressively accommodate the difference in shape between the respective cross-sections of the upstream end 40A and the downstream end 40B of the channel 40. The channel 40 allows, when the material is pushed through the die 30 from the upstream side 30A of the die, this material to flow along the axis X-X from the upstream end 40A to the downstream end 40B of the channel 40, if necessary by progressively accommodating the difference in shape between the respective cross-sections of the upstream end 40A and the downstream end 40B.

Also, as clearly visible in FIGS. 4, 5 and 9, each of the branches 50.1 and 50.2 presents an upstream end 50.1A, 50.2A which, according to the axis X-X, is located in an intermediate region between the upstream and the downstream sides of the upstream module 31. The respective upstream ends 50.1A and 50.2A of the branches 50.1 and 50.2 are located at the same level according to the axis X-X, being arranged on either side of this axis X-X. In the embodiment shown in the figures, these two upstream ends 50.1A and 50.2A communicate directly with each other transversely to the axis X-X; in other words, these upstream ends 50.1A and 50.2A are not physically separated from each other, but are contiguous on either side of the axis X-X. In all cases, the upstream ends 50.1A and 50.2A of the branches 50.1 and 50.2 are, according to the axis X-X, abutted to the downstream end 40B of the channel 40 to allow the flow of material between the channel 40 and the branches 50.1 and 50.2. The cross-section of the upstream ends 50.1A and 50.2A, taken together, of the branches 50.1 and 50.2 is advantageously adjusted to the cross-section of the downstream end 40B of the channel 40, in particular to limit pressure losses or disturbances in the flow of material. In the example embodiment under consideration in the figures, this cross-section of the upstream ends 50.1A and 50.2A taken together thus presents the same rectangular outline, centered on the axis X-X, as the cross-section of the downstream end 40B of the channel 40.

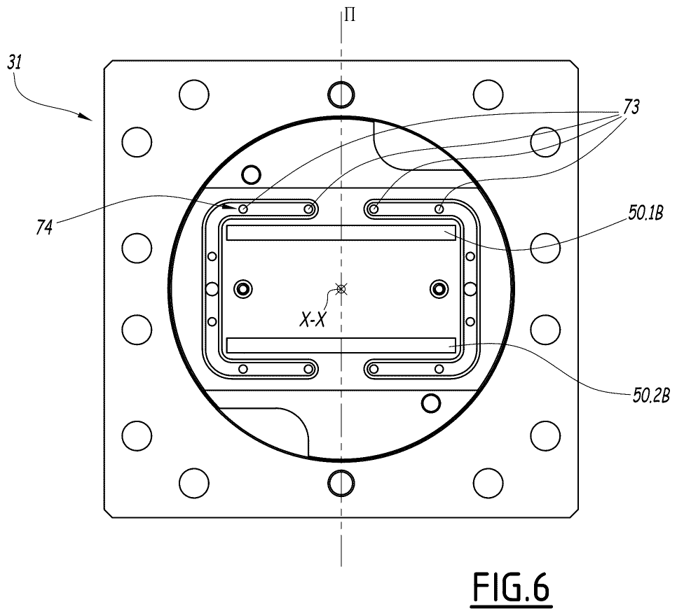

As opposed to their upstream ends 50.1A, 50.2A, the branches 50.1 and 50.2 each present a downstream end 50.1B, 50.2B. These two downstream ends 50.1B and 50.2B open out in a distinct manner on the downstream side of the upstream module 31, as clearly visible in FIGS. 6 and 8. In the assembled state of the extrusion machine 2, in particular in the assembled state of the die 30, the downstream end 50.1B of the branch 50.1 is, according to the axis X-X, abutted to the duct 60.1 to allow the material to flow between the branch 50.1 and the duct 60.1, while the downstream end 50.2B of the branch 50.2 is, according to the axis X-X, abutted to the duct 60.2 to allow the material to flow between the branch 50.2 and the duct 60.2.

As can be seen from FIGS. 4, 5, 7 and 9, the branches 50.1 and 50.2 extend from their upstream ends 50.1A and 50.2A to their downstream ends 50.1B and 50.2B, both in a straight manner and diverging from one another on either side of the axis X-X. Thus, when travelling along the axis X-X from the level where the upstream ends 50.1A and 50.2A of the branches 50.1 and 50.2 are located to the level where the downstream ends 50.1B and 50.2B of the branches 50.1 and 50.2 are located, the branches 50.1 and 50.2 gradually move away from each other on either side of the axis X-X, the increase in this distance between the branches 50.1 and 50.2 being constant. The branches 50.1 and 50.2 allow, when the material is pushed through the die 30 from the upstream side 30A of the die, this material to be distributed into two distinct streams which flow through the branches 50.1 and 50.2 from the respective upstream ends 50.1A and 50.2A to the respective downstream ends 50.1B and 50.2B of these branches. The straightness of the branches 50.1 and 50.2 tends to balance this distribution of material between the two aforementioned flows, by allowing the two flows to flow in a straight line from the downstream end 40B of the channel 40 to the ducts 60.1 and 60.2. Thus, the two aforementioned streams flow in the branches 50.1 and 50.2 from their upstream ends 50.1A and 50.2A to their downstream ends 50.1B and 50.2B in a direction that is inclined relative to the axis X-X at a constant angle of inclination. By preventing the inclination of this flow direction from being altered between the channel 40 and the ducts 60.1 and 60.2, disturbances on the flow of material are limited, as well as the pressure losses.

According to one practical and efficient embodiment, which is implemented in the example embodiment shown in the figures, the branches 50.1B and 50.2B extend from their upstream ends 50.1A and 50.2A to their downstream ends 50.1B and 50.2B, in a symmetrical manner on either side of the axis X-X, or are symmetrical to each other relative to the axis X-X. This arrangement allows the material pushed through the die 30 to be distributed in a uniform manner between the branches 50.1 and 50.2.

In the embodiment shown in the figures, the straightness of the branches 50.1 and 50.2 results from the fact that these branches 50.1 and 50.2 are delimited by both:
the respective flat surfaces 51.1 and 51.2 of the upstream module 31, which are both perpendicular to the same geometric plane π containing the axis X-X and which are located on either side of the axis X-X, each being turned away from the axis X-X, these two surfaces 51. 1 and 51.2 extending from the respective upstream ends 50.1A and 50.2A to the respective downstream ends 50.1B and 50.2B of the branches 50.1 and 50.2, diverging from one another, in particular in a symmetrical manner relative to the axis X-X, and
respective flat surfaces 52.1 and 52.2 of the upstream module 31, which are both perpendicular to the geometric plane π and are located on either side of the axis X-X, each turned toward the axis X-X, these two flat surfaces 52. 1 and 52.2 extend from the respective upstream ends 50.1A and 50.2A to the respective downstream ends 50.1B and 50.2B of the branches 50.1 and 50.2, diverging from one another, in particular in a symmetrical manner relative to the axis X-X.

Note that the geometric plane π corresponds to the sectional plane of FIGS. 2, 4 and 9. Due to their flat conformation over the entire axial extent of the branches 50.1 and 50.2, the flat surfaces 51.1 and 52.1 of the branch 50.1 direct the flow of material in this branch 50.1 in a straight line from the channel 40 to the duct 60.1, and the flat surfaces 51.2 and 52.2 of the branch 50.2 direct the flow of material in this branch 50.2 in a straight line from the channel 40 to the duct 60.2. At the upstream ends 50.1A and 50.2A of the branches 50.1 and 50.2, the flat surfaces 52.1 and 52.2 are separated from each other, forming, in the example under consideration here, the opposite longitudinal edges of the rectangular outline presented by the cross-section of these upstream ends 50.1A and 50.2A taken together, while the flat surfaces 51.1 and 51.2 meet to form a divergence prism.

In the example embodiment under consideration in the figures, the flat surfaces 51.1 and 52.1 of the branch 50.1 are substantially parallel to each other and, by symmetry relative to the axis X-X, the flat surfaces 51.2 and 52.2 of the branch 50.2 are substantially parallel to each other. The surfaces 51.1, 51.2, 52.1 and 52.2 are thus all inclined relative to the axis X-X at substantially the same angle, noted a in FIG. 4. According to a preferential dimensioning allowing greater control of the flow of material in the branches 50.1 and 50. 2, notably by limiting turbulence in this flow, the angle α is less than 30°, or even less than 20°, or even less than 15°, or even less than 12°, or even less than 10°, or even less than 8°, or even less than 5°: by limiting the inclination of the flat surfaces 51.1, 51.2, 52.1 and 52.2 relative to the axis X-X, this allows the material to flow from the channel 40 to the ducts 60.1 and 60.2 by avoiding excessive deflection, which could disrupt the stable flow of material in the branches 50.1 and 50.2. However, as non-represented alternatives, the flat surfaces 51.1 and 52.1 of the branch 50.1 can be provided to be non-parallel between each other and the flat surfaces 51.2 and 52.2 of the branch 50.2 can also be provided to be non-parallel between each other, it being noted that the angles at which the flat surfaces 51.1, 51.2, 52.1 and 52. 2 are respectively inclined relative to the axis X-X advantageously respecting the aforementioned preferential dimensioning; in particular, the flat surfaces 51.1 and 52.1 of the branch 50.1 can thus be provided to converge towards each other downstream, and the flat surfaces 51.2 and 52.2 of the branch 50.2 can also be provided to converge toward each other downstream.

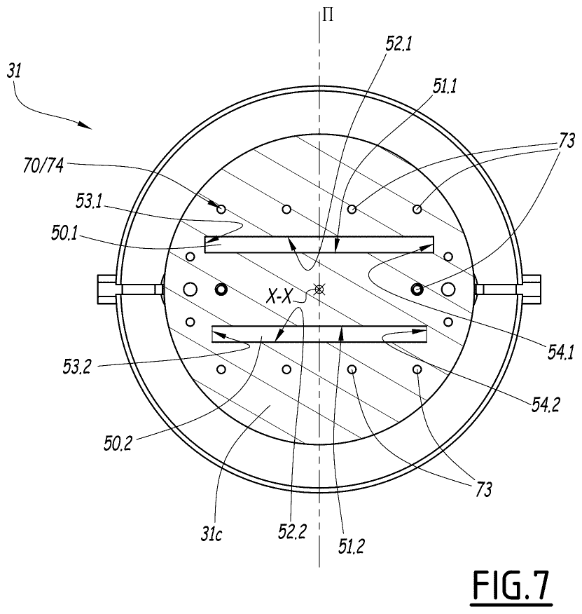

In any case, according to an advantageous embodiment which is implemented in the example under consideration in the figures, each of the branches 50.1 and 50.2 is also delimited by the surfaces 53.1 and 54.1, respectively 53.2 and 54.2, of the upstream module 31: as clearly visible in FIGS. 5 and 7, these flat surfaces 53.1 and 54.1 for the branch 50.1, respectively 53.2 and 54.2 for the branch 50.2, are located on either side of the axis X-X, each extending from the upstream end 50.1A to the downstream end 50.1B of the branch 50.1, respectively from the upstream end 50.2A to the downstream end 50.2B of the branch 50.2. In the example under consideration in the figures, these flat surfaces 53.1 and 54.1 for the branch 50.1, respectively 53.2 and 54.2 for the branch 50.2, are both flat, being parallel to the geometric plane π. As a result, each branch 50.1, 50.2 presents, in any plane perpendicular to the axis X-X between the upstream ends 50.1A, 50.2A and the downstream ends 50.1B, 50.2B of the branch, a section having a rectangular outline, the opposite longitudinal edges of which correspond to the flat surfaces 51.1 and 52.1, respectively 51.2 and 52.2, and the opposite width edges of which correspond to the flat surfaces 53.1 and 54.1, respectively 53.2 and 54.2, this rectangular outline having a constant longitudinal dimension over the entire axial extent of the branch 50.1, 50.2. Thus, over the entire axial extent of each of the branches 50.1 and 50.2, the branch has a dimension, taken orthogonally to the geometric plane π, which is constant and which is advantageously equal to the corresponding dimension of the cross-section of the downstream end 40B of the channel 40, which tends to ensure that the flow of material in the branches 50.1 and 50.2 is totally oriented parallel to the geometric plane π, in particular without this flow presenting any substantial transverse component. In an alternative, not shown, the flat surfaces 53.1 and 54.1 for the branch 50.1, respectively 53.2 and 54.2 for the branch 50.2, can be rounded at their junction with the flat surfaces 51.1 and 52.1, respectively 51.2 and 52.2, conferring, to the aforementioned outline, a rectangular shape with rounded corners. According to yet another alternative not shown, the surfaces 53.1 and 54.1 for the branch 50.1, respectively 53.2 and 54.2 for the branch 50.2, can be concave from their junction with the flat surface 51.1 to their junction with the surface 52.1, respectively from their junction with the flat surface 51.2 to their junction with the flat surface 52.2, thus conferring, to the aforementioned outline, an oblong shape.

In line with the above considerations, but generalizing them, it should be noted that the straightness of the branches 50.1 and 50.2 and, where applicable, their slight inclination relative to the axis X-X do not necessarily require the use of the flat surfaces 51.1, 51.2, 52.1 and 52.2 presented in detail above. Indeed, in alternatives, not shown, it is conceivable to delimit the branches 50.1 and 50.2 by the surfaces of the upstream module 31, presenting geometries other than that of the flat surfaces 51.1, 51.2, 52.1 and 52.2, as long as these surfaces ensure both the straightness of the branches 50.1 and 50.2 from their upstream end 50.1A, 50.2A to their downstream ends 50.1B, 50.2B and, if necessary, the slight inclination of the corresponding straight direction of each of the branches, so that the material flows in the branches, from the channel 40 to the ducts 60.1 and 60.2, in a controlled manner, in particular by limiting the turbulence and the pressure losses. Thus, according to a preferential arrangement generalizing the description above in connection with the flat surfaces 51.1, 51.2, 52.1 and 52.2, each branch 50.1, 50.2 is designed to present, from its upstream end 50.1A, 50.2A to its downstream end 50.1B, 50.2B, a succession of sections in respective planes perpendicular to the axis X-X, these sections defining respective centers the union of which forms a branch axis Z50.1, Z50.2, which is straight and forms with the axis X-X an angle of less than 30°, or even less than 20°, or even less than 15°, or even less than 12°, or even less than 10°, or even less than 8°, or even less than 5°. Applied to the embodiment envisaged in the figures and described in detail above, this arrangement means that, on the one hand, the branch axis Z50.1, Z50.2 corresponds to the straight line passing through the respective centers of the rectangular outlines of the sections presented by the corresponding branch 50.1, 50.2 in any plane perpendicular to the axis X-X over the entire axial extent of the branch and, secondly, the angle formed between the branch axis Z50.1, Z50.2 and the axis X-X corresponds to the angle a.

Whatever the specificity of the branches 50.1 and 50.2, a preferential dimensioning relating to the cross-section of these branches consists in providing that the cumulative cross-section of the branches 50.1 and 50.2 in a plane both perpendicular to the axis X-X and located at the respective distal ends 50.1B and 50.2B of the branches is equal to or less than (i) the cumulative cross-section of the branches in any plane both perpendicular to the axis X-X and located upstream of the respective distal ends 50.1B and 50.2B of the branches and (ii) the cross-section of the channel 40 in any plane both perpendicular to axis X-X and located between the upstream end 40A and the downstream end 40B of the channel 40. In this way, when the material is pushed through the die 30, the flow of material in the channel 40 and in the branches 50.1 and 50.2 is undisturbed and performed in a controlled manner.

In practice, the upstream module 31 presents a constituent structure which is not restrictive, as long as it allows the upstream module 31 to be assembled within the extrusion machine 2 and to delimit both the channel 40 and the branches 50.1 and 50.2, whatever the specific features of this channel and these branches. In the example under consideration in the figures, the upstream module 31 includes for this purpose, three elements successively juxtaposed according to the axis X-X, from the upstream side to the downstream side of the upstream module 31, namely an element 31a, which, on its own, delimits substantially the entire channel 40, and the elements 31b and 31c, which together delimit substantially the entire branches 50.1 and 50.2. The element 31a is securely fastened to the end plate 13, for example by a fastening collar 31d. The elements 31a, 31b and 31c are securely fastened to each other, in particular in pairs, for example, by means of the fastening collars 31e and 31f. The element 31c is securely fastened to the downstream module 32, for example by a fastening flange 31g. One of the advantages of this structure with several axially juxtaposed elements relates to the manufacture of the upstream module 31. A further advantage of this multi-element structure for the upstream module 31 will become apparent later. In practice, the number of elements in this multi-element structure is not limited to three, but could be greater than three or equal to two. As an alternative, not shown, the upstream module may also present a one-piece structure in the portion delimiting both the channel 40 and the branches 50.1 and 50.2. In all cases, it should be noted that, particularly for reasons related to the constituent structure of the upstream module 31, the angle α associated with each of the branches 50.1, 50.2 may not be rigorously constant throughout the axial extent of the branch, but may be only substantially constant, varying slightly, typically in proportions related to manufacturing and assembly clearances. Similarly, each of the flat surfaces 51.1, 51.2, 52.1 and 52.2 may present a flatness that is not strictly uniform over the entire axial extent of the branch concerned.

The ducts 60.1 and 60.2 will now be described in more detail. As indicated above, these ducts 60.1 and 60.2 are delimited by the downstream modules 32, 33, 34 and 35: more precisely, the downstream modules 32 to 35 delimit respective portions, following one another according to the axis X-X, of the duct 60.1 and also delimit respective portions, following one another according to the axis X-X, of the duct 60.2.

As can be seen from FIGS. 2, 4 and 9, each of the ducts 60.1 and 60.2 presents an upstream end 60.1A, 60.2A which opens onto the upstream side of the downstream module 32. In the assembled state of the extrusion machine 2, in particular in the assembled state of the die 30, the upstream end 60.1A of the duct 60.1 abuts, according to the axis X-X, the downstream end 50.1B of the branch 50.1 to allow the flow of material between the branch 50.1 and the duct 60.1, while the upstream end 60.2A of the duct 60.2 abuts, according to the axis X-X to the downstream end 50.2B of the branch 50.2 to allow the flow of material between the branch 50.2 and the duct 60.2. The cross-section of the upstream end 60.1A of the duct 60.1 is advantageously adjusted to the section, in a plane, perpendicular to the axis X-X, of the downstream end 50.1B of the branch 50.1, while the cross-section of the upstream end 60.2A of the duct 60. 2 is advantageously adjusted to the section, in a plane, perpendicular to the axis X-X, of the downstream end 50.2B of the branch 50.2, notably to limit the pressure losses or disturbances in the flow of material between the branch 50.1 and the duct 60.1 and between the branch 50.2 and the duct 60.2.

As can be seen from FIG. 2, each of the ducts 60.1 and 60.2 presents, opposite its upstream end 60.1A, 60.2A. A downstream end 60.1B, 60.2B These two downstream ends 60.1B and 60.2B open out in a distinct manner on the downstream side of the downstream module 35, in other words, on the downstream side 30B of the die 30.

As can be seen from FIGS. 2, 4 and 9, the ducts 60.1 and 60.2 extend from their upstream ends 60.1A, 60.2A to their downstream ends 60.1B, 60.2B, on either side of the axis X-X and in a manner substantially parallel to this axis X-X. The ducts 60.1 and 60.2 allow, when material is pushed through the die 30 from the upstream side 30A of this die, the flow of this material parallel to the axis X-X in the form of two distinct streams of material, one of which leaves the branch 50.1 and progresses in the duct 60.1 from the upstream end 60.1A to the downstream end 60.1B of this duct 60.1, while the other of these two streams of material leaves the branch 50.2 and progresses in the duct 60.2 from the upstream end 60.2A to the downstream end 60.2B of this duct 60.2.

According to a practical and efficient embodiment, which is implemented in the example under consideration in the figures, the ducts 60.1 and 60.2 extend from their upstream ends 60.1A and 60.2A to their downstream ends 60.1B and 60.2B in a symmetrical manner on either side of the axis X-X, or are even symmetrical to each other relative to the axis X-X. In particular, this arrangement allows to homogenize the flow of material through the die 30 between the ducts 60.1 and 60.2.

In the embodiment under consideration in the figures, the cross-section of each of the ducts 60.1 and 60.2 is constant between the upstream ends 60.1A, 60.2A and the downstream ends 60.1B, 60.2B of the duct. As can be clearly seen in FIG. 3, this cross-section of the ducts 60.1 and 60.2 presents a rectangular outline, the longitudinal edges of which extend perpendicularly to the geometric plane π. Here, this rectangular outline is adjusted to that of the section, in a plane perpendicular to the axis X-X, of the downstream ends 50.1B and 50.2B of the branches 50.1 and 50.2. This rectangular conformation of the cross-sectional outline of the ducts 60.1 and 60.2 means that the flow of the product 1.1 and 1.2 each presents the form of a substantially parallelepiped strip, with a rectangular cross-section. According to a preferred dimensioning which is directly related to the thickness of the strips forming the product streams 1.1 and 1.2 respectively, the rectangular outline of the cross-section of each of the ducts 60.1 and 60.2 presents a width of between 4 and 25 mm, preferably between 6 and 20 mm. According to the considerations similar to those developed above concerning possible alternatives for the cross-sectional outline of each of the branches 50.1 and 50.2, the cross-sectional outline of each of the ducts 60.1 and 60.2 can, in an alternative, not shown, be rectangular with rounded corners or else be oblong. However, other alternative, geometric shapes, not shown, are also possible for the cross-sectional outline of the ducts 60.1 and 60.2, being noted that the geometry chosen for this outline determines the geometric shape of the product streams 1.1 and 1.2.

In practice, the downstream modules 32 to 35 each present a constituent structure which is not limited, as long as the respective structures of the downstream modules 32 to 35 allow both these downstream modules within the extrusion machine 2 to be assembled and the ducts 60.1 and 60.2, to be delimited, in particular, regardless of the specific features of these ducts 60.1 and 60.2. In all cases, the respective structures of the downstream modules 32 to 35 allow notably to securely fasten these modules to one another, in particular by assembling them in pairs using, for example, the fastening flanges 36a, 36b and 36c. According to a particularly advantageous arrangement for economic and practical reasons, the downstream modules 32 to 35 are individually identical to one another, thus presenting the same constituent structure which is repeated for each of the downstream modules 32 to 35, as in the example envisaged in the figures.

Furthermore, a preferred form for this structure is that each downstream module 32, 33, 34, 35 includes two superimposed pairs of superimposed blocks, with interposition between two blocks of each pair of a pair of spacers in such a manner that the ducts 60.1 and 60.2 are jointly defined by these blocks and spacers. More precisely, as illustrated for the downstream module 32 in FIG. 3, this downstream module 32 includes the blocks 32a, 32b, 32c and 32d, as well as a pair of spacers 32e and a pair of spacers 32f: the spacers 32e are interposed between adjacent superimposed blocks 32a and 32b in such a manner that these blocks 32a and 32b and the spacers 32e jointly define the duct 60.1 at the downstream module 32, while the spacers 32f are interposed between adjacent superimposed blocks 32c and 32d in such a manner that these blocks 32c and 32d and the spacers 32f together define the duct 60.2 at the downstream module 32. The blocks 32a, 32b, 32c and 32d and the spacers 32e and 32f are securely assembled together, for example by bolting. One of the advantages of this block and spacer structure relates to the manufacture of the downstream modules 32 to 35: in particular, by adjusting the dimensions of the spacers 32e and 32f, the dimensions of the cross-section of the ducts 60.1 and 60.2 are easily modified, for example the width and length values of the rectangular outline of the cross-section of the ducts 60.1 and 60.2 illustrated in the figures. A further advantage of this block structure for the downstream modules 32 to 35 will become apparent later. In an alternative, not shown, each downstream module 32 to 35 is devoid of spacers, such as the spacers 32e and 32f, but at least some of its blocks present a U-shaped cross-section: for example, the blocks 32a and 32d are similar to those shown in the figures, but the block 32b presents a U-shaped cross-section turned toward the block 32a and the block 32c presents a U-shaped cross-section turned toward the block 32d. According to yet another alternative, not shown, the blocks 32b and 32c are made in one and the same piece, which means that the structure of each downstream module 32 to 35 includes not four superimposed blocks, as shown in the figures, but only three superimposed blocks, the intermediate block serving, on one side, to define the duct 60.1 while the opposite side of this intermediate block serves to define the duct 60.2; in this case, it is conceivable either to provide spacers similar to the spacers 32e and 32f, or not to provide such spacers and to provide that the cross-section of the intermediate block is H-shaped and/or that the cross-section of the other two blocks is U-shaped.

Whatever the specifics of the channel 40, the branches 50.1 and 50.2 and the ducts 60.1 and 60.2, the die 30 is temperature controlled in the sense that the die 30 is designed to control its temperature in such a manner, at least locally, to maintain this temperature at a given, advantageously adjustable, value, despite heat exchanges with its immediate environment. In particular, the die 30 is able to act (i) on the temperature in the ducts 60.1 and 60.2, more precisely on the temperature of the material flowing in these ducts 60.1 and 60.2, by means of heat exchange between this material and the downstream modules 32 to 35 through the wall of the ducts 60.1 and 60.2, (ii) on the temperature in the branches 50.1 and 50. 2, more precisely on the temperature of the material flowing in these branches 50.1 and 50.2, by means of heat exchange between this material and the upstream module 31 through the wall of the branches 50.1 and 50.2, and (iii) on the temperature in the channel 40, more precisely on the temperature of the material flowing in this channel 40, by means of heat exchange between this material and the upstream module 31 through the wall of the channel 40.

To this end, the die 30 is equipped with temperature control means 70, in other words temperature control equipment, able to control the wall temperature of the ducts 60.1 and 60.2 and to control the wall temperature of the branches 50.1 and 50.2, as well as to control the wall temperature of the channel 40. One embodiment for these temperature control means 70, which is implemented in the example shown in the figures, is detailed below.

Each of the downstream modules 32 to 35 is provided with passages 71 for the circulation of a temperature controlled fluid, for example pressurized water. The passages 71 are located in the wall of the ducts 60.1 and 60.2, advantageously being integrated directly into the aforementioned blocks belonging to the downstream modules 32 to 35, such as blocks 32a, 32b, 32c and 32d for the downstream module 32, as clearly visible in FIG. 3, the aforementioned blocks then being provided to be thermally conductive. The passages 71 allow the circulation of a temperature controlled fluid which, by heat exchange with the wall of the ducts 60.1 and 60.2, controls the temperature of the latter in such a manner that the temperature of the material flowing through the ducts 60.1 and 60.2 at the downstream module under consideration is adjusted, for example lowered or kept constant. Naturally, each of the downstream modules 32 to 35 includes both one or more temperature controlled fluid inlets, which allow the passages 71 to be supplied with the temperature controlled fluid having a controlled temperature, and one or more temperature controlled fluid outlets, which allow the temperature controlled fluid to be discharged from the passages 71. According to an advantageous arrangement, the passages 71 extend parallel to the axis X-X over most, or all of the axial extent of the downstream module under consideration, to allow a temperature profile to be applied along the respective portions of the ducts 60.1 and 60.2 delimited by the downstream module under consideration. According to another advantageous arrangement, potentially cumulative with the previous arrangement, the downstream modules 32 to 35 and/or the blocks of each module, such as the blocks 32a, 32b, 32c and 32d of the module 32, are temperature controlled independently of one another.

The embodiment just described, in connection with the passages 71 is only one possible embodiment for, more generally, a portion 72 of the temperature control means 70, which is integrated into the downstream modules 32 to 35 and which allows the wall temperature of the ducts 60.1 and 60.2 to be controlled.

Furthermore, still within the scope of the description of the example of the temperature control means 70, illustrated in the figures, the upstream module 31 is provided with the passages 73 for the circulation of a temperature controlled fluid, for example pressurized water. As can be clearly seen from FIGS. 5 to 7, the passages 73 are located in the wall of the branches 50.1 and 50.2 and in the wall of the channel 40, for example, by being integrated directly into the elements 31c, 31b and 31a of the upstream module 31. The passages 73 allow the circulation of a temperature controlled fluid which, by heat exchange with the wall of the branches 50.1 and 50.2 and with the wall of the channel 40, controls the temperature of these walls in such a manner that the temperature of the material flowing in the channel 40 and in the branches 50.1 and 50.2 is adjusted, for example, lowered or kept constant. Of course, according to the considerations similar to those indicated above for the passages 71, the upstream module 31 includes one or more temperature controlled fluid inlets for supplying the passages 73, as well as one or more temperature controlled fluid outlets for discharging the temperature controlled fluid from the passages 73. According to an advantageous arrangement, at the branches 50.1 and 50.2, the passages 73 extend parallel to the branches 50.1 and 50.2 over most of, or all of, the axial extent of the branches to allow a temperature profile to be applied along the branches 50.1 and 50.2. Similarly, at the channel 40, the passages 73 extend parallel to the channel 40 over most of, or all of, the axial extent of the channel to allow a temperature profile to be applied along channel 40. According to a further advantageous arrangement, potentially cumulative with the above, the elements 31a, 31b and 31c of the upstream module 31 are temperature controlled independently of each other.

Of course, the embodiment just described in connection with the passages 73 is only one possible embodiment for, more generally, a portion 74 of the temperature control means 70, which is integrated into the upstream module 31 and which allows the wall temperature of the branches 50.1 and 50.2 and the wall temperature of the channel 40.

Furthermore, the extrusion machine 2 is advantageously associated with a conveying tool 80 which, as can be clearly seen in FIGS. 1 and 2, is arranged on the downstream side 30B of the die 30. This conveying tool 80 is designed to individually convey the two product streams 1.1 and 1.2 leaving the die 30. In practice, the embodiment of the conveying tool 80 is not limiting as long as this conveying tool comprises two conveying elements, such as conveyor belts, which act respectively on the product streams 1.1 and 1.2 in such a manner as to convey each product stream independently of the other product stream, typically for post treatment. It is understood that this conveyor tool 80 takes advantage of the fact that the ducts 60.1 and 60.2 of the die 30 open in a distinct manner on the downstream side 30B of the die.

The operation of the extrusion machine 2 will now be described.

The raw material ingredients 3 fed into the barrel 10, via at least one of its elements 11, are then driven downstream by the screws 20, while being transformed under the effect of the thermomechanical treatment applied by the barrel and the screws. The material 4 leaving the most downstream of the elements 11 of the barrel 10 is pushed successively through the end plate 13 and the die 30. The material 4 enters the die 30 through the channel 40, in which it flows from the upstream end 40A to the downstream end 40B, where it reaches the upstream ends 50.1A and 50.2A of the branches 50.1 and 50.2. The material is then divided into two distinct material streams, which flow respectively through the branches 50.1 and 50.2, from their upstream ends 50.1A and 50.2A to their downstream ends 50.1B and 50.2B. The two material streams then reach the ducts 60.1 and 60.2 respectively, progressing from their upstream ends 60.1A and 60.2A to their downstream ends 60.1B and 60.2B. Thus, the progression of the material through the ducts 60.1 and 60.2 to the downstream side 30B of the die 30 results from the material being pushed through the die from the upstream side 30A of the die. The two streams of material then reach the downstream side 30B of the die 30, where these two streams of material leave the ducts 60.1 and 60.2 in the form of the two product streams 1.1 and 1.2 constituting the food product 1. These two product streams 1.1 and 1.2 are individually taken over by the conveyor tool 80.

Thanks to the straightness and, advantageously, the slight inclination of the branches 50.1 and 50.2, as well as the temperature control of the wall of the channel 40 and of the wall of the branches 50.1 and 50.2, the formation and flow, within the die 30, of the two streams of material sent into the ducts 60.1 and 60.2 are controlled, even including at high material flow rates, in particular, by avoiding pressure losses and flow disturbances that could induce uncontrolled material behavior in view of its viscosity. In particular, despite the considerable axial extent of the branches 50.1 and 50.2, due to their straightness and slight inclination, the portion 74 of the temperature control means 70 allows the skin effect between the wall of branches 50.1 and 50.2 and the material flowing through these branches to be limited. As a result, the fibration of the material flowing through the ducts 60.1 and 60.2 can be controlled in a fine, efficient and reproducible manner, thanks in particular to the temperature control of the walls of these ducts 60.1 and 60.2.

Various modifications and alternatives of the extrusion machine 2 described so far are also conceivable. By way of example, various corresponding aspects are listed below, which can be considered in isolation with the above or in combination with each other:
The number of downstream modules 32 to 35 is not limited to four, but can be less than four, or even one, or on the contrary, more than four.
Rather than being made in modular form, as with the upstream 31 and the downstream 32 to 35 modules, the die 30 can be designed as a non-modular overall body, which successively delimits the channel 40, the branches 50.1 and 50.2 and the ducts 60.1 and 60.2, and which integrates the portions 72 and 74 of the temperature control means 70. In practice, such an assembly body includes several parts securely assembled to one another.
At the outlet of the barrel 10 and/or at the inlet of the die 30, a diffusion grid can be placed over the flow of material 4. An example of such a diffusion grid can be seen in FIGS. 4, 5 and 9 under reference 90. However, the presence of such a diffusion grid is not essential, which means that, in the example conceived in the figures, the diffusion grid 90 can be removed in favor of a completely open diaphragm.
The end plate 13 can be temperature controlled, in such a manner as to control the temperature of the wall of the bore 15, using arrangements similar to those described above for the upstream module 31.
In the example shown in the figures, the axis X-X extends horizontally and the geometric plane π extends vertically, so that the product streams 1.1 and 1.2 leave the die 30 one above the other according to the vertical. Alternatively, while keeping the axis X-X horizontal, the geometric plane π can be provided to extend horizontally, with the product streams 1.1 and 1.2 then leaving the die 30 at the same vertical height, but horizontally side by side.

1. A die for extruding a material rich in proteins and water,
which die defines a die axis and has two opposite sides according to the die axis, namely an upstream side through which the material enters the die and a downstream side through which the material leaves the die,
which die delimits successively according to the direction of the die axis:
a channel which extends in a manner centered on the die axis from an upstream end, opening onto the upstream side of the die, to a downstream end,
two branches, which extend on either side of the die axis, diverging from each other, from respective upstream ends, axially abutting the downstream end of the channel, to respective downstream ends, each of the branches extending substantially in a straight line from the upstream end of the branch to the downstream end of the branch, and
two ducts, which extend on either side of and in a manner substantially parallel to the die axis from respective upstream ends, abutting respectively the downstream ends of the branches, to respective downstream ends, opening onto the downstream side of the die, each of the ducts having a cross-section, in a plane perpendicular to the die axis, which is constant between the upstream end and the downstream end of the duct,
in such a manner that, when the material is pushed through the die from the upstream side, the material flows into the channel and is then distributed in the branches before reaching the ducts in which, under effect of the material being pushed through the die from the upstream side, the material progresses to the downstream side where the material leaves the ducts in the form of two respective product streams,
and which die is provided with a temperature control equipment able (i) to control a wall temperature of the ducts, (ii) to control a wall temperature of the branches and (iii) to control a wall temperature of the channel.

2. The die according to claim 1, wherein each of the branches has, from the upstream end of the branch to the downstream end of the branch, a succession of sections in respective planes perpendicular to the die axis, which sections define respective centers, an union of which forms a branch axis that is substantially straight and forms with the die axis an angle of less than 30°.

3. The die according to claim 1, wherein the branches are delimited by:
respective substantially flat first surfaces of the die, which are both perpendicular to the same geometric plane containing the die axis and which are located on either side of the die axis, each being turned away from the die axis, these two substantially flat first surfaces extend from the respective upstream ends to the respective downstream ends of the branches, diverging from one another, and
respective substantially flat second surfaces of the die, which are both perpendicular to the geometrical plane and are located on either side of the die axis, each being turned toward the die axis, these two substantially flat second surfaces extend from the respective upstream ends to the respective downstream ends of the branches, diverging from one another.

4. The die according to claim 3, wherein the substantially flat first surface and the substantially flat second surface of each of the branches are substantially parallel to each other and are inclined relative to the die axis at substantially the same angle which is less than 30°.

5. The die according to claim 3, wherein the section of each of the ducts in a plane perpendicular to the die axis has a substantially rectangular outline having longitudinal edges that extend in a manner substantially perpendicular to the geometric plane, a width of the substantially rectangular outline being between 4 and 25 mm.

6. The die according to claim 1, wherein the cumulative section of the branches in a plane both perpendicular to the die axis and located at the respective downstream ends of the branches is equal to or less than:
a cumulative section of the branches in any plane both perpendicular to the die axis and located upstream of the respective downstream ends of the branches, and
a section of the channel in any plane both perpendicular to the die axis and located between the upstream end and the downstream end of the channel.

7. The die according to claim 1, wherein the die includes modules juxtaposed successively to one another according to the die axis from the upstream side to the downstream side of the die, namely:
an upstream module, which delimits both the channel and the branches and incorporates a first portion of the temperature control equipment, able to control the wall temperature of the branches and the wall temperature of the channel, and
one or more downstream modules, which delimit the ducts and incorporate a second portion of the temperature control equipment, able to control the wall temperature of the ducts.

8. A system for continuously preparing an extruded food product, comprising:
a raw material which is rich in proteins and water,
a barrel inside which at least one screw is driven in such a manner as to apply a thermomechanical treatment to the raw material, and
a die, which is in accordance with claim 1 and which is attached to the barrel in such a manner that the material leaving the barrel is pushed by the at least one screw through the die from the upstream side of the die.

9. The system according to claim 8, wherein the barrel includes, at a downstream end of the barrel, an end plate delimiting a through bore which is centered on the die axis and which abuts the upstream end of the channel in such a manner that the bore directs the material pushed by the at least one screw toward the channel.

10. The system according to claim 8, wherein the system further includes a conveying tool that is arranged on the downstream side of the die and is able to convey the two product streams individually.
